(19) United States
(12) Patent Application Publication
(10) Pub. No.: US 2018/0022188 A1
(43) Pub. Date: Jan. 25, 2018

(54) AIR CONDITIONER FOR VEHICLE

(71) Applicant: Honda Motor Co.,Ltd., Tokyo (JP)

(72) Inventors: Shinji KAKIZAKI, Saitama (JP); Junichi KANEMARU, Saitama (JP)

(73) Assignee: Honda Motor Co.,Ltd., Tokyo (JP)

(21) Appl. No.: 15/650,976

(22) Filed: Jul. 17, 2017

(30) Foreign Application Priority Data
Jul. 19, 2016 (JP) 2016-141566

(51) Int. Cl. B60H 1/32; B60H 1/00

(52) U.S. Cl. CPC B60H 1/3202; B60H 1/3227; B60H 1/00735; B60H 1/00; F25B 13/00

(57) ABSTRACT

To provide an air conditioner for a vehicle includes an evaporator, a heater core, an air conditioning passage, an inside air introduction passage, an outside air introduction passage, and a heat pipe. In the air conditioning passage, a ventilation portion of the heater core is disposed downstream from a ventilation portion of the evaporator. Through the heat pipe, heat is transferred from a high temperature portion on the inside air introduction passage side to a low temperature portion on the outside air introduction passage side due to evaporation and condensation of a refrigerant. The heat pipe is provided in the evaporator to straddle a position facing the inside air introduction passage and a position facing the outside air introduction passage.

### CROSS-REFERENCE TO RELATED APPLICATION

This application claims the priority benefit of Japan Application no. 2016-141566, filed on Jul. 19, 2016. The entirety of the above-mentioned patent application is hereby incorporated by reference herein and made a part of this specification.

### BACKGROUND OF THE INVENTION

### Field of the Invention

The present invention relates to an air conditioner for a vehicle having a dehumidification function.

### Description of Related Art

Many air conditioners for a vehicle include an evaporator configured to absorb heat of conditioned air according to a refrigeration cycle, and a heater core configured to heat conditioned air using cooling water of an engine, a heat pump cycle, a heating heater and the like. These kinds of air conditioner for a vehicle can appropriately control a temperature and humidity in a cabin according to a combination of heat absorption by the evaporator and heating by the heater core.

Incidentally, when a heating operation is performed in cold weather and the like, the inside of a windshield sometimes becomes foggy due to water vapor emitted from an occupant or moisture of clothes brought into the cabin. In such a case, it is possible to remove fogging of the windshield by blowing dehumidified and heated air from a defroster opening of an air conditioner for a vehicle.

However, while a temperature in an air conditioning passage is extremely low, it is difficult to sufficiently vaporize a refrigerant by the evaporator and an amount of refrigerant introduced into the evaporator should be reduced. Therefore, when an amount of refrigerant introduced into the evaporator is greatly reduced, an amount of lubricating oil that circulates together with the refrigerant in a refrigerant circuit is also reduced and sufficient lubricating oil is less likely to return to a compressor in the refrigerant circuit.

In addition, when heat absorption is performed by the evaporator while a temperature in the air conditioning passage is extremely low, freezing may occur around the evaporator and dehumidification in the air conditioner may not be performed.

In order to address such problems, an air conditioner for a vehicle in which, when a windshield is foggy in a low temperature environment, low temperature outside air having little moisture is taken in and heated by a heater core, and is then blown to a windshield portion from a defroster opening, and on the other hand, air taken in from the inside of the cabin is heated by the heater core, and is blown from a foot opening into the cabin has been devised.

However, in this air conditioner for a vehicle, since low temperature outside air is heated by the heater core and is blown from the defroster opening to the windshield portion, a great amount of thermal energy is necessary for heating and it is not possible for the air conditioner to perform indoor air dehumidification.

In order to address such problems, an air conditioner for a vehicle in which a heat pipe having high heat transfer efficiency is disposed between an inside air introduction passage and an outside air introduction passage of an air conditioning unit, and low temperature outside air taken into the outside air introduction passage is heated using the heat pipe has been devised (for example, refer to Patent Document 1). The heat pipe is filled with a predetermined amount of a volatile refrigerant and is disposed to straddle the inside air introduction passage and the outside air introduction passage on the upstream side of the evaporator and the heater core in the air conditioning unit. Through the heat pipe, heat is efficiently transferred from the inside air introduction passage to the outside air introduction passage due to evaporation and condensation of an internal refrigerant in cold weather, air that passes through the inside air introduction passage is cooled, and air in the cabin is dehumidified.

### PRIOR ART DOCUMENT

### Patent Documents

[Patent Document 1] Japanese Laid-Open Patent Publication No. 1998-6746

### SUMMARY OF THE INVENTION

In the air conditioner for a vehicle described in Japanese Laid-Open Patent Publication No. 1998-6746, since air in the outside air introduction passage passes through the heat pipe and is efficiently heated by high temperature air in the inside air introduction passage and inside air that passes through the inside air introduction passage is dehumidified through the heat pipe, an amount of inside air circulation air dehumidified while collecting heat in the cabin is increased and it is possible to efficiently perform dehumidification and heating operations.

However, in the air conditioner for a vehicle described in Japanese Laid-Open Patent Publication No. 1998-6746, since the heat pipe is disposed between the inside air introduction passage and the outside air introduction passage positioned on a side further upstream from the evaporator and a blower in the air conditioning passage, a structure in the passage including the blower is complicated and the entire device easily becomes larger in size.

Therefore, the present invention provides an air conditioner for a vehicle in which, when dehumidification and heating are performed in cold weather, heat exchange between an inside air introduction passage and an outside air introduction passage is performed through a heat pipe so that it is possible to increase an amount of inside air circulation air dehumidified while collecting heat in a cabin, and moreover, the heat pipe can be installed in an air conditioning passage easily and compactly.

In order to address the above problems, an air conditioner for a vehicle according to the present invention has the following configurations.

That is, the air conditioner for a vehicle according to the present invention includes an evaporator (for example, an evaporator 11 of an embodiment) configured to cool conditioned air, a heater core (for example, a heater core 14 of the embodiment) configured to heat conditioned air, an air conditioning passage (for example, an air conditioning passage 15 of the embodiment) in which a ventilation portion of the heater core is disposed downstream from a ventilation portion of the evaporator and conditioned air blown into a cabin is generated, an inside air introduction passage (for example, an inside air introduction passage 16 of the embodiment) which is connected to an upstream side of the ventilation portion of the evaporator of the air conditioning passage and through which air in the cabin is introduced to the ventilation portion of the evaporator, an outside air introduction passage (for example, an outside air introduction passage 17 of the embodiment) which is connected to an upstream side of the ventilation portion of the evaporator of the air conditioning passage in parallel with the inside air introduction passage and through which air outside the vehicle is introduced to the ventilation portion of the evaporator, and a heat pipe (for example, a heat pipe 33 of the embodiment) through which heat is transferred from a high temperature portion to a low temperature portion due to evaporation and condensation of a refrigerant. The heat pipe is provided in the evaporator to straddle a position facing the inside air introduction passage and a position facing the outside air introduction passage.

According to the above configuration, when dehumidification and heating are performed in cold weather, it is possible to introduce outside air from the outside air introduction passage to the air conditioning passage and introduce inside air from the inside air introduction passage. In this case, when outside air and inside air are introduced into the evaporator portion from the outside air introduction passage and the inside air introduction passage, in the heat pipe portion provided in the evaporator, heat is exchanged between air on the high temperature inside air introduction passage side and air on the low temperature outside air introduction passage side. Accordingly, while low temperature outside air introduced from the outside air introduction passage is heated and introduced into the cabin, high temperature inside air introduced from the inside air introduction passage is cooled and the inside air whose moisture has been removed is introduced again into the cabin. As a result, it is possible to increase an amount of inside air circulation air dehumidified while collecting heat in the cabin.

In addition, since the heat pipe is provided in the evaporator, it is possible to install it in the air conditioning passage together with the evaporator easily and compactly.

A portion of the evaporator which is connected to the outside air introduction passage may be disposed above a portion of the evaporator which is connected to the inside air introduction passage.

In this case, a portion of the evaporator which is connected to the outside air introduction passage is disposed above the heat pipe and a portion of the evaporator which is connected to the inside air introduction passage is disposed below the heat pipe. Therefore, when dehumidification and heating are performed in cold weather, a high temperature portion is positioned below the heat pipe and a low temperature portion is positioned above the heat pipe. Therefore, it is possible to efficiently transfer heat from the inside air introduction passage side to the outside air introduction passage side without a complicated structure of the heat pipe itself.

The evaporator includes a plurality of refrigerant passages in rows (for example, first heat exchange tubes 52 and second heat exchange tubes 53 of the embodiment) that extend in a direction intersecting a ventilation portion on the inside air introduction passage side and a ventilation portion on the outside air introduction passage side. The heat pipe may be disposed between adjacent refrigerant passages of the evaporator. In this case, since the heat pipe is disposed between adjacent refrigerant passages of the evaporator, the heat pipe does not protrude to the outside of the evaporator, and it is possible to reduce the size of the outer shape of the heat pipe and the evaporator in combination.

In the heat pipe, a refrigerant sealing valve (for example, a refrigerant sealing valve 42 of the embodiment) for sealing a refrigerant may be provided.

In this case, when the refrigerant is enclosed in the heat pipe, it is possible to easily fill the refrigerant through the refrigerant sealing valve.

The plurality of refrigerant passages in rows of the evaporator may be made of a pipe member.

In addition, the plurality of refrigerant passages in rows of the evaporator may be made of a plurality of plate members (for example, a plate member 45 of the embodiment) that are bonded to each other.

In this case, it is possible to further simplify the structure of the evaporator and reduce manufacturing costs.

A refrigeration cycle (for example, a refrigeration cycle 12 of the embodiment) to which the evaporator is connected includes a sealing portion (for example, an expansion valve 28, a shutoff valve 31, and an interlocking mechanism portion 32 of the embodiment) capable of sealing a refrigerant that circulates through the inside in a refrigerant passage of the evaporator. The heat pipe may be formed in a state in which the refrigerant is sealed in the refrigerant passage by the sealing portion.

In this case, when dehumidification and heating are performed in cold weather, the refrigerant in the refrigeration cycle is sealed in the refrigerant passage of the evaporator by the sealing portion. Therefore, the refrigerant passage of the evaporator and the refrigerant therein function as the heat pipe. Accordingly, when such a configuration is used, a dedicated heat pipe is unnecessary and it is possible to reduce the number of components and it is possible to provide a more compact device.

The inside air introduction passage and the outside air introduction passage are partitioned by a partition wall (for example, an upstream partition wall 18 of the embodiment) and disposed adjacent to each other. A heat transfer member (for example, fins 40 of the embodiment) that exchanges heat between air that passes through the inside of the inside air introduction passage and air that passes through the inside of the outside air introduction passage may be provided on the partition wall.

In this case, before heat is exchanged between inside air and outside air through the heat pipe, heat exchange between inside air and outside air is performed also in the heat transfer member of the partition wall. Accordingly, when such a configuration is used, it is possible to further increase efficiency of heat exchange between inside air and outside air introduced into the air conditioner for a vehicle and increase dehumidification efficiency.

An insulating material for blocking heat exchange between outside air that passes through the inside of the outside air introduction passage and air in the surrounding regions may be disposed on the outer periphery of the outside air introduction passage.

In this case, since heat exchange between outside air that passes through the inside of the outside air introduction passage and air in the surrounding region is blocked by the insulating material, heat of the outside air that passes through the outside air introduction passage is more efficiently exchanged with the inside air that passes through the inside air introduction passage.

A drain passage (for example, a drain passage 241 of the embodiment) from which condensed water generated from introduced air in the cabin is discharged to the outside is provided in the inside air introduction passage. An air outlet (for example, an air outlet 241a of the embodiment) from which introduced air in the cabin is discharged to the outside together with the condensed water may be provided in the drain passage.

In this case, when heat exchange between inside air and outside air is performed in the heat transfer member of the partition wall and moisture in air that passes through the inside air introduction passage is condensed in the heat transfer member portion, the generated condensed water is discharged to the outside of the inside air introduction passage through the drain passage. In this case, since relatively warm introduced air in the cabin is discharged from the drain passage through the air outlet together with the condensed water, it is difficult for the condensed water that passes through the drain passage to freeze.

According to the present invention, the heat pipe through which heat is transferred from a high temperature portion to a low temperature portion due to evaporation and condensation of a refrigerant is provided in the evaporator to straddle a position facing the inside air introduction passage and a position facing the outside air introduction passage. Therefore, when dehumidification and heating are performed in cold weather, heat is exchanged between the inside air introduction passage and the outside air introduction passage via the heat pipe, and it is possible to increase an amount of inside air circulation air dehumidified while collecting heat in the cabin. In addition, it is possible to install the heat pipe in the air conditioning passage easily and compactly.

### BRIEF DESCRIPTION OF THE DRAWINGS

FIG. 1 is a schematic cross-sectional view of an air conditioner for a vehicle according to a first embodiment of the present invention.

FIG. 2 is a cross-sectional view of the air conditioner for a vehicle according to the first embodiment of the present invention taken along the line II-II in FIG. 1.

FIG. 3 is a cross-sectional view of the air conditioner for a vehicle according to the first embodiment of the present invention taken along the line in FIG. 1.

FIG. 4 is a schematic cross-sectional view of an air conditioner for a vehicle according to a second embodiment of the present invention.

FIG. 5 is a cross-sectional view of the air conditioner for a vehicle according to the second embodiment of the present invention taken along the line V-V in FIG. 4.

FIG. 6 is a schematic cross-sectional view of an air conditioner for a vehicle according to a third embodiment of the present invention.

FIG. 7 is a schematic cross-sectional view of an evaporator and a heat pipe of an air conditioner for a vehicle according to a fourth embodiment of the present invention.

FIG. 8 is a schematic cross-sectional view of a part of the evaporator and the heat pipe of the air conditioner for a vehicle according to the fourth embodiment of the present invention.

FIG. 9 is a schematic cross-sectional view of an evaporator of an air conditioner for a vehicle according to a fifth embodiment of the present invention.

FIG. 10 is a cross-sectional view of the air conditioner for a vehicle according to the fifth embodiment of the present invention taken along the line X-X in FIG. 9.

FIG. 11 is a schematic cross-sectional view of an evaporator and a heat pipe of an air conditioner for a vehicle according to a sixth embodiment of the present invention.

FIG. 12 is a schematic configuration diagram showing a refrigeration cycle of an air conditioner for a vehicle according to a seventh embodiment of the present invention.

### DESCRIPTION OF THE EMBODIMENTS

Embodiments of the present invention will be described below with reference to the drawings.

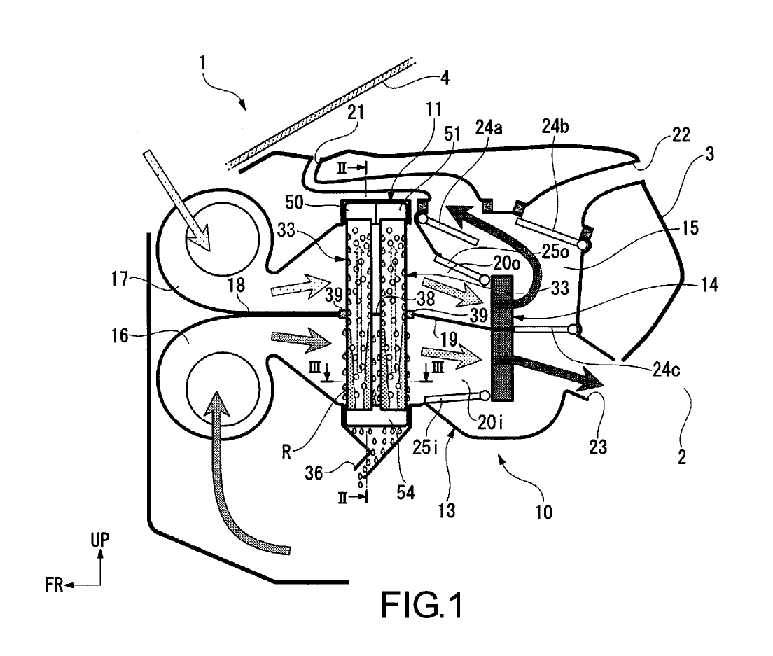

First, a first embodiment shown in FIG. 1 to FIG. 3 will be described.

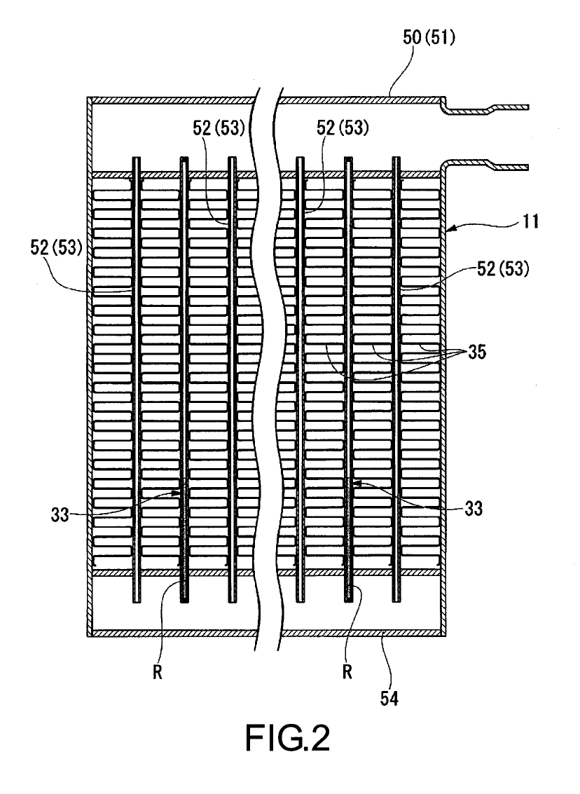

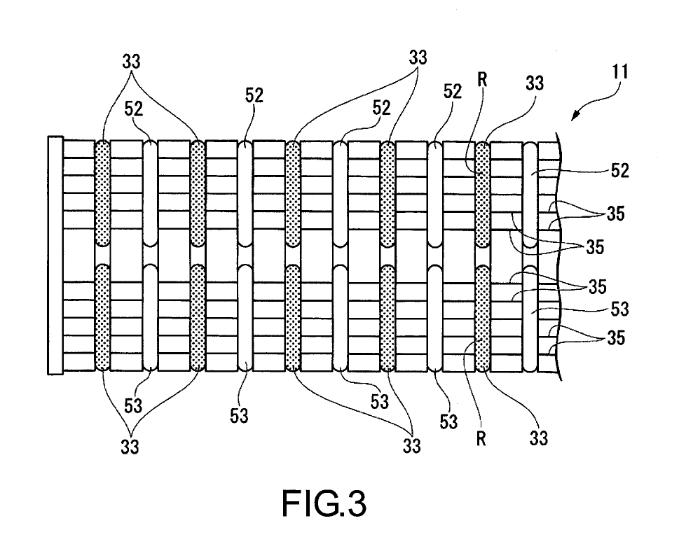

FIG. 1 is a diagram showing a vertical cross section of an air conditioner for a vehicle 10 substantially in a vehicle body longitudinal direction. FIG. 2 is a diagram showing a cross section of an evaporator 11 taken along the line II-II in FIG. 1. In addition, FIG. 3 is a diagram showing a cross section of the evaporator 11 taken along the line in FIG. 1. Here, in FIG. 1, an arrow FR indicates the front of a vehicle 1, and an arrow UP indicates the upper side of the vehicle 1.

As shown in FIG. 1, in the air conditioner for a vehicle 10, an air conditioning unit 13 configured to adjust a temperature and humidity of conditioned air blown into a cabin 2 is installed, for example, in an inside part of an instrument panel 3 in front of the cabin 2. In the air conditioning unit 13, the evaporator 11 configured to absorb heat from conditioned air and a heater core 14 configured to heat conditioned air are disposed in an air conditioning passage 15. The evaporator 11 constitutes a part of a refrigeration cycle (not shown). The heater core 14 includes a heat pump cycle, a heating heater, and the like. Here, when a vehicle in which an internal combustion engine is mounted is used, the heater core 14 may perform heating using cooling water of the internal combustion engine. The heater core 14 is disposed downstream from the evaporator 11 in the air conditioning passage 15.

As shown in FIG. 1, on the upstream side of the evaporator 11 in the air conditioning unit 13, an inside air introduction passage 16 into which air in the cabin 2 is taken and an outside air introduction passage 17 into which air outside the vehicle is taken are connected in parallel. Along the inside air introduction passage 16 and the outside air introduction passage 17, a blower (not shown) configured to send inside air and outside air toward the evaporator 11 is disposed. In addition, along the inside air introduction passage 16 and the outside air introduction passage 17, a passage opening and closing damper (not shown) is disposed. When the damper is controlled by a control device, opening and closing are appropriately performed.

Portions downstream from the outside air introduction passage 17 and the inside air introduction passage 16 are connected to portions upstream from a ventilation portion of the evaporator 11 so that the outside air introduction passage 17 is positioned above the inside air introduction passage 16. A portion upstream from the evaporator 11 in the air conditioning unit 13 is partitioned into the outside air introduction passage 17 and the inside air introduction passage 16 by an upstream partition wall 18.

In addition, in the present embodiment, a space between the evaporator 11 and the heater core 14 in the air conditioning passage 15 is partitioned into an inside air introduction portion 20i and an outside air introduction portion 20o by a downstream partition wall 19 which is continuous with the upstream partition wall 18.

On the downstream side of the air conditioning passage 15 in the air conditioning unit 13, a defroster opening 21 through which conditioned air is blown below a windshield 4 in the cabin 2, a vent opening 22 through which conditioned air is blown in front of an occupant in the cabin 2, and a foot opening 23 through which conditioned air is blown toward the feet of an occupant in the cabin 2 are provided. Opening and closing dampers 24a, 24b, and 24c configured to perform opening and closing control via the control device are provided at the defroster opening 21, the vent opening 22, and the foot opening 23. Here, the opening and closing damper 24c configured to open and close the foot opening 23 can vertically partition a space on the downstream side from the heater core 14 while the foot opening 23 is open.

The air conditioning unit 13 includes a first air mix door 25o configured to adjust a ratio of conditioned air that passes through the heater core 14 to conditioned air that bypasses the heater core 14 at the outside air introduction portion 20o downstream from the evaporator 11. In addition, the air conditioning unit 13 includes a second air mix door 25i configured to adjust a ratio of conditioned air that passes through the heater core 14 to conditioned air that bypasses the heater core 14 at the inside air introduction portion 20i downstream from the evaporator 11. The first air mix door 25o and the second air mix door 25i have a degree of opening and closing that is appropriately controlled by the control device and adjust a temperature of conditioned air blown from any of the vent opening 22, the foot opening 23, and the defroster opening 21.

While a refrigeration cycle (not shown) including the evaporator 11 as a part is not shown in detail herein, it has roughly the following configuration.

That is, the refrigeration cycle includes a compressor configured to compress a refrigerant to a high pressure and expel the refrigerant, an outdoor heat exchanger configured to exchange heat between the refrigerant compressed by the compressor and outside air, an expansion valve that expands the refrigerant that has passed through the outdoor heat exchanger, and the above evaporator 11 configured to exchange heat between the low temperature and low pressure refrigerant that has passed through the expansion valve and conditioned air and return the refrigerant of which heat has been exchanged with conditioned air to the compressor.

The evaporator 11 includes a refrigerant inflow tank 50 into which a refrigerant flows from an expansion valve side (a discharge portion side of the compressor) of the refrigeration cycle and a refrigerant outflow tank 51 from which a refrigerant flows out to a suction portion side of the compressor of the refrigeration cycle. The refrigerant inflow tank 50 and the refrigerant outflow tank 51 are disposed on the upper end side of the evaporator 11 to be substantially horizontally parallel to each other in a vehicle width direction.

The evaporator 11 further includes a plurality of first heat exchange tubes 52 (refer to FIG. 2 and FIG. 3) whose upper ends are connected to the refrigerant inflow tank 50, a plurality of second heat exchange tubes 53 (refer to FIG. 2 and FIG. 3) whose upper ends are connected to the refrigerant outflow tank 51, and a relay tank 54 (refer to FIG. 1) that connects the first heat exchange tubes 52 and the second heat exchange tubes 53. The first heat exchange tubes 52 and the second heat exchange tubes 53 are disposed substantially in a vertical direction. The relay tank 54 is disposed substantially in a vehicle width direction at the lower end of the evaporator 11. The first heat exchange tubes 52 and the second heat exchange tubes 53 are made of a metallic pipe member having substantially an elliptical cross section and have an inside that forms a refrigerant passage in the evaporator 11. In addition, a plurality of fins 35 protrude from the outer peripheries of the first heat exchange tubes 52 and the second heat exchange tubes 53. The outer peripheries of the first heat exchange tubes 52 and the second heat exchange tubes 53 are ventilation portions through which conditioned air passes. The fins 35 increase efficiency of heat exchange between the internal refrigerant and conditioned air in the ventilation portions.

Here, the first heat exchange tubes 52 and the second heat exchange tubes 53 are provided to correspond to each other in a one-to-one correspondence and corresponding tubes are disposed side by side in a vehicle width direction. In FIG. 2, a reference numeral 53 of the second heat exchange tubes 53 positioned behind the first heat exchange tubes 52 is added in parenthesis after a reference numeral 52 of the first heat exchange tubes 52. Similarly, in FIG. 2, a reference numeral 51 of the refrigerant outflow tank 51 positioned behind the refrigerant inflow tank 50 is added in parenthesis after a reference numeral 50 of the refrigerant inflow tank 50.

The refrigerant that has passed through the expansion valve of the refrigeration cycle and flowed into the refrigerant inflow tank 50 of the evaporator 11 passes through the plurality of first heat exchange tubes 52 and flows into the relay tank 54. A direction of the refrigerant is changed in the relay tank 54 and the refrigerant passes through the plurality of second heat exchange tubes 53 and flows into the refrigerant outflow tank 51. The refrigerant having flowed into the refrigerant outflow tank 51 flows out to the suction portion side of the compressor of the refrigeration cycle.

In addition, heat pipes 33 are disposed between adjacent first heat exchange tubes 52 and adjacent second heat exchange tubes 53 of the evaporator 11. In the heat pipe 33, a predetermined amount of a refrigerant R is enclosed in a metallic tube having approximately the same size as the first heat exchange tubes 52 and the second heat exchange tubes 53 and having substantially an elliptical cross section. Through the heat pipe 33, heat is transferred from a high temperature portion to a low temperature portion due to evaporation and condensation of the refrigerant R. In the present embodiment, the upper end and the lower end of the heat pipe 33 disposed between adjacent first heat exchange tubes 52 are engaged with the refrigerant inflow tank 50 and the relay tank 54, and the upper end and the lower end of the heat pipe 33 disposed between adjacent second heat exchange tubes 53 are engaged with the refrigerant outflow tank 51 and the relay tank 54. In addition, the plurality of fins 35 for promoting heat exchange protrude from the outer peripheries of the heat pipes 33.

The heat pipes 33 are attached to the evaporator 11 to straddle a position facing the inside air introduction passage 16 and a position facing the outside air introduction passage 17. Therefore, when dehumidification and heating are performed, if air in the warm cabin 2 is introduced into the inside air introduction passage 16 on the lower side and cold air outside the vehicle is introduced into the outside air introduction passage 17 on the upper side, the refrigerant R remained in the lower part in the heat pipe 33 vaporizes (evaporates) and absorbs heat from warm air on the inside air introduction passage 16 side, and the refrigerant in the upper part in the heat pipe 33 is liquefied (condensed) and heats cold air on the outside air introduction passage 17 side.

As shown in FIG. 1, a partition portion 38 that partitions a passage portion of outside air and a passage portion of inside air together with the upstream partition wall 18 and the downstream partition wall 19 is provided at a substantially center portion of the evaporator 11 and the heat pipe 33 in the vertical direction. In addition, a sealing member 39 for preventing air leakage is provided between the evaporator 11 and each of the upstream partition wall 18 and the downstream partition wall 19.

In addition, a drain port 36 from which condensed water generated in the evaporator portion 11 is discharged to the outside of the air conditioning unit 13 is provided at a position below the evaporator 11 in the air conditioning unit 13.

In the air conditioner for a vehicle 10 according to the present embodiment, when dehumidification and heating operations causing defogging of the windshield 4 are performed in cold weather, air outside the vehicle is introduced into the outside air introduction passage 17 and air in the cabin 2 is introduced into the inside air introduction passage 16. In this state, the defroster opening 21 and the foot opening 23 are opened by the opening and closing dampers 24a and 24c. Here, at this time, when the first air mix door 25o and the second air mix door 25i block a bypass passage portion, the whole of the air introduced into the outside air introduction portion 20o and the inside air introduction portion 20i passes through the heater core 14.

In this case, air outside the vehicle introduced from the outside air introduction passage 17 passes through the upper portion of the heat pipe 33 installed at the evaporator 11 and the upper portion of the heater core 14 on the downstream side thereof and is blown from the defroster opening 21 to the windshield 4 portion. In addition, air in the cabin 2 introduced from the inside air introduction passage 16 passes through the lower portion of the heat pipe 33 installed at the evaporator 11 and the lower portion of the heater core 14 and is blown to a foot portion of an occupant from the foot opening 23.

While all of the air blown from the defroster opening 21 and the foot opening 23 is warmed by the heater core 14 and blown into the cabin 2, since air blown from the defroster opening 21 is outside air and air blown from the foot opening 23 is air in the cabin 2, the air blown from the defroster opening 21 has a lower temperature than the air blown from the foot opening 23. Therefore, it is necessary to further heat the air blown from the defroster opening 21.

However, outside air introduced from the outside air introduction passage 17 exchanges heat with inside air that has passed through the inside air introduction passage 16 via the heat pipe 33 in the evaporator 11 portion. Therefore, the air blown from the defroster opening 21 is efficiently warmed through heat exchange via the heat pipe 33. Therefore, outside air that is sufficiently warmed and dried is blown to the windshield 4 from the defroster opening 21.

On the other hand, inside air introduced from the inside air introduction passage 16 is cooled via the heat pipe 33 in the evaporator 11 portion, and moisture contained in the inside air drops downward as condensed water and is discharged to the outside of the air conditioning unit 13 from the drain port 36. Accordingly, humidity of the air blown from the foot opening 23 is sufficiently removed when passing through the evaporator 11 portion.

As described above, in the air conditioner for a vehicle 10 according to the present embodiment, the heat pipe 33 through which heat is transferred from a high temperature portion to a low temperature portion due to evaporation and condensation of the refrigerant is integrally attached to the evaporator 11 to straddle a position facing the inside air introduction passage 16 and a position facing the outside air introduction passage 17 in the air conditioning unit 13. Therefore, in the air conditioner for a vehicle 10 according to the present embodiment, when dehumidification and heating are performed in cold weather, if heat exchange between the inside air introduction passage 16 and the outside air introduction passage 17 is performed via the heat pipe 33, it is possible to increase an amount of inside air circulation air dehumidified while collecting heat in the cabin. In addition, since the heat pipe 33 is integrally attached to the evaporator 11, it is possible to install the heat pipe 33 in the air conditioning passage 15 easily and compactly.

In addition, in the air conditioner for a vehicle 10 according to the present embodiment, since a portion of the evaporator 11 which is connected to the outside air introduction passage 17 is disposed above a portion of the evaporator 11 which is connected to the inside air introduction passage 16, when dehumidification and heating are performed in cold weather, the high temperature portion is disposed below the heat pipe 33 and the low temperature portion is positioned above the heat pipe 33. Therefore, the heat pipe 33 can exchange efficiently heat between the inside air introduction passage 16 and the outside air introduction passage 17 without a complicated structure.

Further, in the air conditioner for a vehicle 10 according to the present embodiment, the heat pipe 33 separate from the evaporator 11 is disposed between adjacent first heat exchange tubes 52 (refrigerant passages) and between adjacent second heat exchange tubes 53 (refrigerant passages) of the evaporator 11. Therefore, in the air conditioner for a vehicle 10 according to the present embodiment, it is possible to provide a simple configuration without requiring complex control, and it is possible to prevent the heat pipe 33 from protruding to the outside of the evaporator 11. Accordingly, when the air conditioner for a vehicle 10 according to the present embodiment is used, it is possible to provide a configuration without requiring complex control and reduce the size of the outer shape of the heat pipe 33 and the evaporator 11 in combination.

In addition, in the air conditioner for a vehicle 10 according to the present embodiment, since a plurality of refrigerant passages in rows of the evaporator 11 are formed of the first heat exchange tubes 52 and the second heat exchange tubes 53 which are made of a pipe member, it is possible to simplify a configuration of the evaporator 11 and manufacture it at low cost, and it is possible to share many components with evaporators having different specifications.

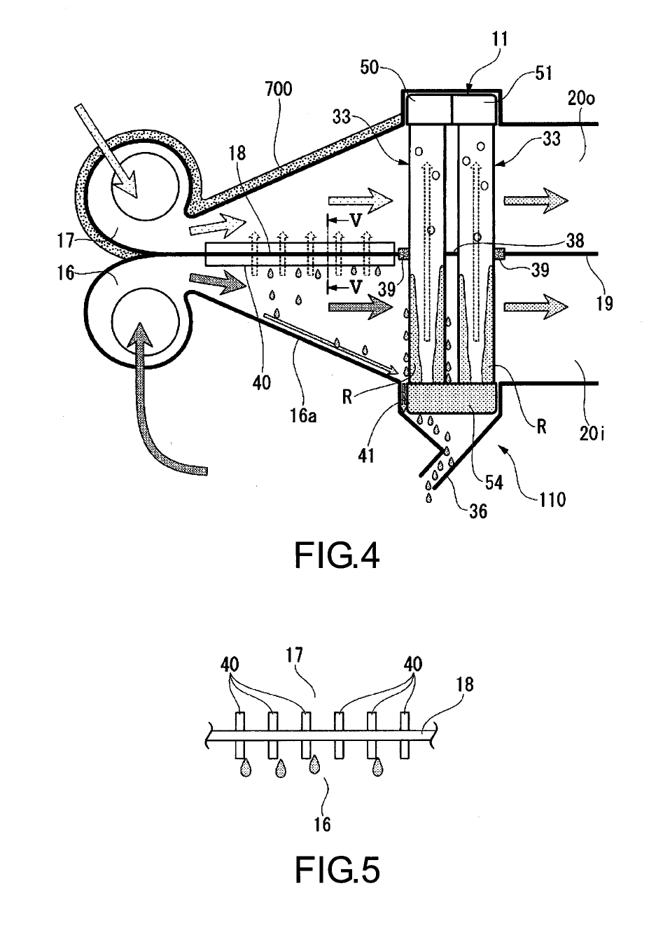

Next, a second embodiment shown in FIG. 4 and FIG. 5 will be described. Also, in the following embodiments to be described below, the same reference numerals denote elements the same as in the first embodiment shown in FIG. 1 to FIG. 3.

FIG. 4 is a diagram showing a vertical cross section of an air conditioner for a vehicle 110 substantially in a vehicle body longitudinal direction. FIG. 5 is a diagram showing a cross section of the air conditioner for a vehicle 110 in FIG. 4 taken along the line V-V. The air conditioner for a vehicle 110 according to the second embodiment has substantially the same basic configuration as that in the first embodiment but is significantly different from that of the first embodiment in that, on the upstream partition wall 18 (partition wall) that partitions the inside air introduction passage 16 and the outside air introduction passage 17, a plurality of fins 40 (transmission members) for heat transfer through which heat exchange between air that passes through the inside of the inside air introduction passage 16 and air that passes through the inside the outside air introduction passage 17 is performed protrude. In addition, a lower wall 16a of the inside air introduction passage 16 is inclined downward in a direction to the evaporator 11, and a drain passage 41 connected to the drain port 36 is formed between an end of the lower wall 16a and the evaporator 11. Condensed water generated in the inside air introduction passage 16 is discharged to the outside from the drain port 36 through the drain passage 41.

In addition, the outer periphery of the outside air introduction passage 17 is covered with an insulating material 700 for blocking heat exchange with air in the surrounding region other than the inside of the inside air introduction passage 16.

The air conditioner for a vehicle 110 according to the present embodiment can obtain the same basic effect as in the air conditioner for a vehicle 10 according to the first embodiment and the plurality of fins 40 serving as heat transfer members protrude from the upstream partition wall 18. Therefore, before heat is exchanged between inside air that has passed through the heat pipe 33 and outside air, heat exchange between inside air and outside air can be performed also in the plurality of fins 40 of the upstream partition wall 18. Accordingly, when the air conditioner for a vehicle 110 according to the present embodiment is used, it is possible to further increase efficiency of heat exchange between inside air and outside air introduced into the cabin 2 and increase dehumidification efficiency.

In addition, in the air conditioner for a vehicle 110 according to the present embodiment, since the outer periphery of the outside air introduction passage 17 is covered with the insulating material 700, it is possible to prevent heat exchange between air in the outside air introduction passage 17 and air in the instrument panel and it is possible to further increase efficiency of heat exchange between inside air in the inside air introduction passage 16 and outside air in the outside air introduction passage 17.

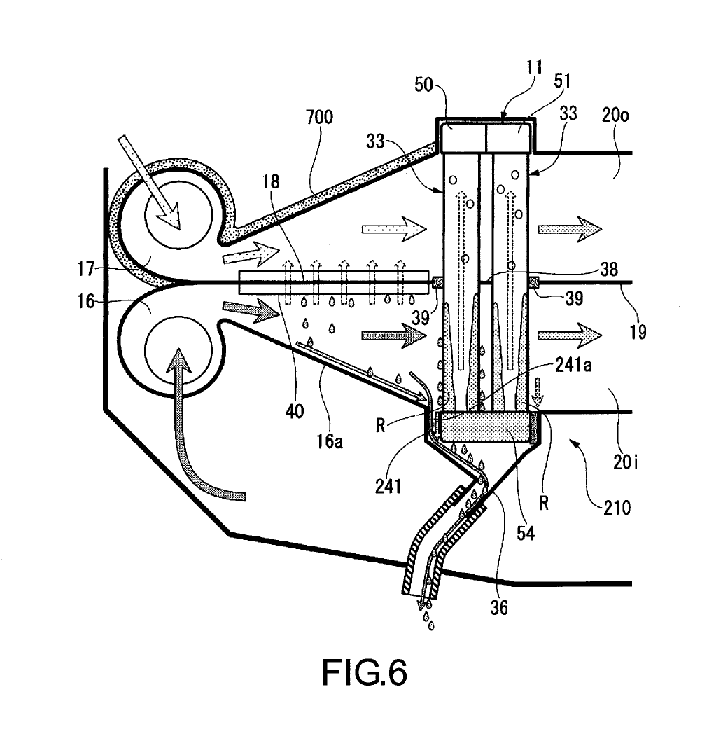

FIG. 6 is a diagram showing a vertical cross section of an air conditioner for a vehicle 210 according to a third embodiment substantially in a vehicle body longitudinal direction.

The air conditioner for a vehicle 210 according to the third embodiment has substantially the same basic configuration as that in the second embodiment except that an opening area of a drain passage 241 formed between an end of the lower wall 16a of the inside air introduction passage 16 and the evaporator 11 is large and a shape by which blocking due to condensed water does not continue is used. In the present embodiment, a part of the drain passage 241 is formed as an air outlet 241a from which warm air in the inside air introduction passage 16 can be discharged to the outside together with the condensed water.

Accordingly, when the air conditioner for a vehicle 210 according to the present embodiment is used, even if dehumidification and heating are performed in cold weather, relatively warm introduced air in the cabin is discharged through the air outlet 241a of the drain passage 241 together with the condensed water. Therefore, it is possible to prevent condensed water that passes through the drain passage 241 from freezing.

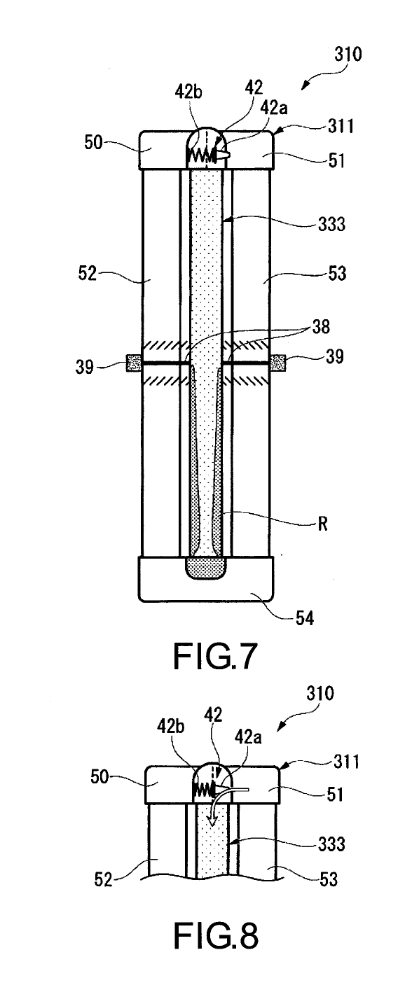

FIG. 7 and FIG. 8 are diagrams showing schematic cross sections of an evaporator 311 and a heat pipe 333 of an air conditioner for a vehicle 310 according to a fourth embodiment.

In the air conditioners for a vehicle 10, 110, and 210 according to the first to third embodiments, the heat pipe 33 is installed between adjacent first heat exchange tubes 52 and between adjacent second heat exchange tubes 53 of the evaporator 11. However, in the air conditioner for a vehicle 310 according to the fourth embodiment, the heat pipe 333 is disposed at positions between the first heat exchange tubes 52 and the second heat exchange tubes 53 in a side view and between adjacent first heat exchange tubes 52 (between the second heat exchange tubes 53) in a front view. As in the first embodiment, in the heat pipe 333, a predetermined amount of the refrigerant R is enclosed in a metallic tube having substantially an elliptical cross section.

In addition, on the heat pipe 333, a refrigerant sealing valve 42 for sealing the refrigerant R inside is provided above a metallic tube filled with a predetermined amount of the refrigerant R. The refrigerant sealing valve 42 is configured as a check valve in which a valve body 42a is biased in a valve closing direction by a spring 42b. As shown in FIG. 8, the valve body 42a is displaced in a valve opening direction only if a high pressure is applied from the outside when the refrigerant R is filled.

Although the heat pipe 333 of the air conditioner for a vehicle 310 according to the present embodiment is slightly different from that of the first embodiment, other basic configurations are substantially the same as those of the first embodiment. Therefore, it is possible to obtain substantially the same basic effect as in the first embodiment.

However, in the air conditioner for a vehicle 310 according to the present invention, the refrigerant sealing valve 42 for sealing a refrigerant inside is provided on the heat pipe 333 separate from the evaporator 311. Therefore, there is an advantage that the refrigerant R can be easily filled through the refrigerant sealing valve 42 when the refrigerant in the heat pipe 333 is enclosed.

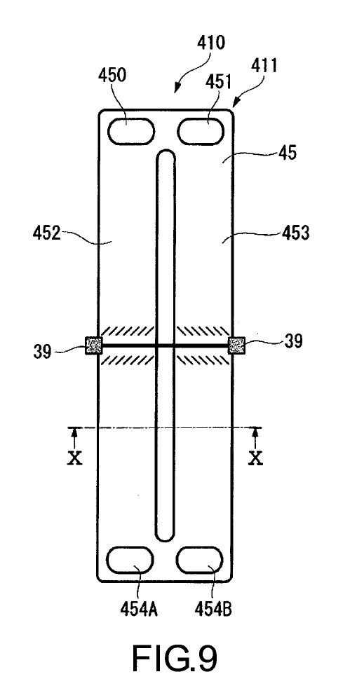

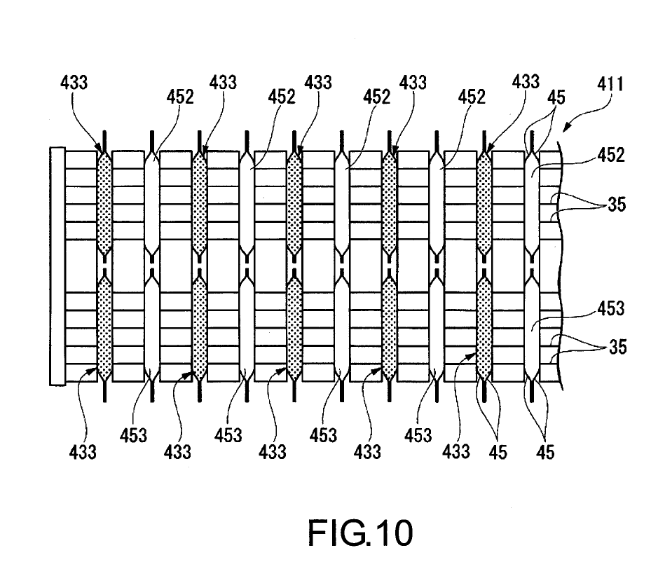

FIG. 9 is a diagram showing a schematic cross section of an evaporator 411 of an air conditioner for a vehicle 410 according to a fifth embodiment. FIG. 10 is a diagram showing a cross section taken along the line X-X in FIG. 9.

In the above-described first to fourth embodiments, the refrigerant inflow tank 50 and the refrigerant outflow tank 51 are disposed in the upper end side of the evaporators 11 and 311 and the relay tank 54 is disposed in the bottom end side, and the first heat exchange tubes 52 and the second heat exchange tubes 53 which are made of a pipe member connect the refrigerant inflow tank 50 and the relay tank 54, and the relay tank 54 and the refrigerant outflow tank 51, respectively. On the other hand, in the evaporator 411 according to the fifth embodiment, a plurality of plate members 45 including a refrigerant inflow hole 450 and a refrigerant outflow hole 451 on the upper end side and relay holes 454A and 454B on the bottom end side are stacked in layers and peripheral portions of the adjacent plate members 45 are appropriately bonded to each other. Accordingly, a first heat exchange tube 452, a second heat exchange tube 453, a heat pipe 433, and the like are formed between adjacent plate members 45. The first heat exchange tube 452 is connected to the refrigerant inflow hole 450 and the relay hole 454A. The second heat exchange tube 453 is connected to the relay hole 454B and the refrigerant outflow hole 451. In addition, the relay hole 454A and the relay hole 454B are connected through a passage hole (not shown).

In the present embodiment, the heat pipe 433 is disposed between adjacent first heat exchange tubes 452 and between adjacent second heat exchange tubes 453. In addition, as in the first embodiment, a predetermined amount of the refrigerant R is enclosed in the heat pipe 433.

In the air conditioner for a vehicle 410 according to the present embodiment, it is possible to obtain substantially the same effect as in the first embodiment. However, since the evaporator 411 includes the plurality of plate members 45 that are stacked in layers, it is possible to further simplify the structure of the evaporator 411 and reduce manufacturing costs.

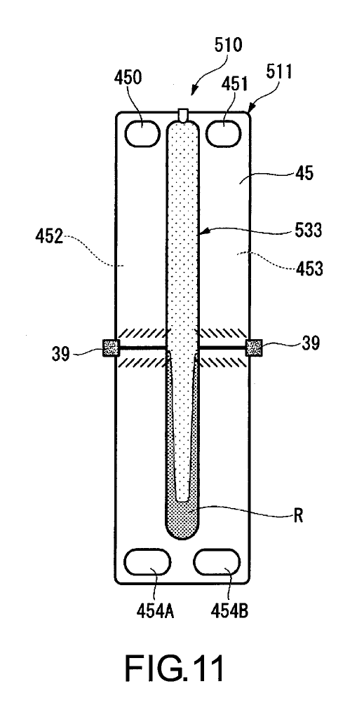

FIG. 11 is a diagram showing a schematic cross section of an evaporator 511 of an air conditioner for a vehicle 510 according to a sixth embodiment.

As in the fifth embodiment, in the air conditioner for a vehicle 510 according to the present embodiment, the plurality of plate members 45 including the refrigerant inflow hole 450, the refrigerant outflow hole 451, and the relay holes 454A and 454B are stacked in layers, peripheral portions of the adjacent plate members 45 are appropriately bonded to each other, and the first heat exchange tube 452 and the second heat exchange tube 453 are formed therebetween. In addition, one heat pipe 533 is formed between backs of the plate members 45 forming the first heat exchange tube 452 and the second heat exchange tube 453.

In the air conditioner for a vehicle 510 according to the sixth embodiment, it is possible to obtain substantially the same effect as in the fourth embodiment and it is possible to further reduce the size of the entire evaporator 511.

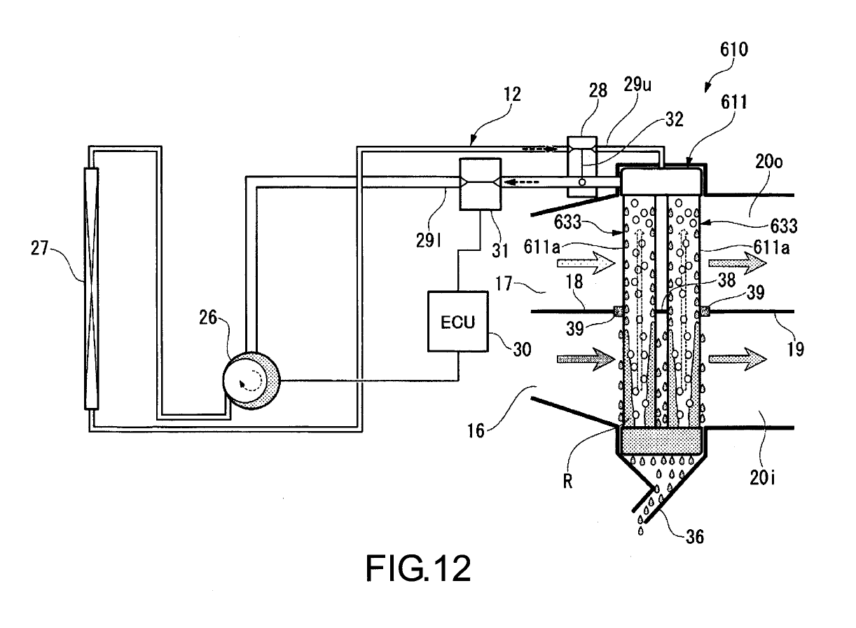

FIG. 12 is a diagram schematically showing a refrigeration cycle of an air conditioner for a vehicle 610 according to a seventh embodiment.

The air conditioner for a vehicle 610 according to the present embodiment does not include a dedicated heat pipe, and a part of an evaporator 611 functions as a heat pipe as necessary, for example, when dehumidification and heating are performed.

A refrigeration cycle 12 includes a compressor 26 configured to compress a refrigerant to a high pressure and expel the refrigerant, an outdoor heat exchanger 27 configured to exchange heat between the refrigerant compressed by the compressor 26 and outside air, an expansion valve 28 that expands the refrigerant that has passed through the outdoor heat exchanger 27, and the evaporator 611 configured to exchange heat between the low temperature and low pressure refrigerant that has passed through the expansion valve 28 and conditioned air and return the refrigerant of which heat has been exchanged with conditioned air to the compressor 26.

In addition, the refrigeration cycle 12 includes a shutoff valve 31 that is interposed along a refrigerant flow path 291 downstream from the evaporator 611 and blocks the refrigerant flow path 291 on the downstream side under control by a control device 30 and an interlocking mechanism portion 32 that closes the expansion valve 28 along a refrigerant flow path 29u on the upstream side according to a blocking operation of the shutoff valve 31. In addition, the compressor 26 of the refrigeration cycle 12 is controlled by the control device 30.

Here, in the present embodiment, the shutoff valve 31, the interlocking mechanism portion 32, and the expansion valve 28 constitute a sealing portion capable of sealing a refrigerant that circulates in the refrigeration cycle 12 in a refrigerant passage 611a of the evaporator 611. Actually, when a predetermined amount of the refrigerant R is sealed in the refrigerant passage 611a of the evaporator 611, the compressor 26 operates for a short time while the shutoff valve 31 is closed by the control device 30. Accordingly, when a predetermined amount of the refrigerant R is filled into the refrigerant passage 611a of the evaporator 611, the interlocking mechanism portion 32 detects a pressure of the refrigerant flow path 291 on the downstream side and closes the expansion valve 28. As a result, a predetermined amount of the refrigerant R is enclosed in the refrigerant passage 611a.

The evaporator 611 functions as a heat pipe 633 through which, when the refrigerant R is thus sealed in the refrigerant passage 611a, the refrigerant passage 611a and the refrigerant R therein transfer heat from a high temperature portion to a low temperature portion due to evaporation and condensation of the refrigerant R. In the present embodiment, the refrigerant passage 611a of the evaporator 611 and the refrigerant R sealed therein constitute the heat pipe 633.

When dehumidification and heating operations start, after the shutoff valve 31 of the refrigeration cycle 12 is closed, the compressor 26 of the refrigeration cycle 12 operates for a short time, and the expansion valve 28 is closed when a pressure in the refrigerant passage 611a of the evaporator 611 increases to a predetermined pressure. Accordingly, the refrigerant R is enclosed in the refrigerant passage 611a, and the refrigerant passage 611a functions as the heat pipe 633 together with the refrigerant therein.

In the air conditioner for a vehicle 610 according to the present embodiment, the refrigeration cycle 12 connected to the evaporator 611 includes the shutoff valve 31 capable of sealing the refrigerant R in the refrigerant passage 611a of the evaporator 611, the interlocking mechanism portion 32, and the expansion valve 28. When dehumidification and heating are performed in cold weather, by sealing the refrigerant in the refrigerant passage 611a of the evaporator 611, this can be used as the heat pipe 633. Therefore, when this configuration is used, since a dedicated heat pipe is unnecessary, it is possible to reduce manufacturing costs by reducing the number of components and it is possible to provide a more compact air conditioner for a vehicle 610.

Here, the present invention is not limited to the above embodiments and various design modifications can be made without departing from the spirit and scope of the present invention.

What is claimed is:

1. An air conditioner for a vehicle comprising:
an evaporator configured to cool conditioned air;
a heater core configured to heat conditioned air;
an air conditioning passage in which a ventilation portion of the heater core is disposed downstream from a ventilation portion of the evaporator and conditioned air blown into a cabin is generated;
an inside air introduction passage which is connected to an upstream side of the ventilation portion of the evaporator of the air conditioning passage and through which air in the cabin is introduced to the ventilation portion of the evaporator;
an outside air introduction passage which is connected to an upstream side of the ventilation portion of the evaporator of the air conditioning passage in parallel with the inside air introduction passage and through which air outside the vehicle is introduced to the ventilation portion of the evaporator; and
a heat pipe through which heat is transferred from a high temperature portion to a low temperature portion due to evaporation and condensation of a refrigerant,
wherein the heat pipe is provided in the evaporator to straddle a position facing the inside air introduction passage and a position facing the outside air introduction passage.

2. The conditioner for a vehicle according to claim 1,
wherein a portion of the evaporator which is connected to the outside air introduction passage is disposed above a portion of the evaporator which is connected to the inside air introduction passage.

3. The air conditioner for a vehicle according to claim 1,
wherein the evaporator includes a plurality of refrigerant passages in rows that extend in a direction intersecting a ventilation portion on the inside air introduction passage side and a ventilation portion on the outside air introduction passage side and
wherein the heat pipe is disposed between the adjacent refrigerant passages of the evaporator.

4. The air conditioner for a vehicle according to claim 2,
wherein the evaporator includes a plurality of refrigerant passages in rows that extend in a direction intersecting a ventilation portion on the inside air introduction passage side and a ventilation portion on the outside air introduction passage side and
wherein the heat pipe is disposed between the adjacent refrigerant passages of the evaporator.

5. The air conditioner for a vehicle according to claim 3,
wherein a refrigerant sealing valve for sealing a refrigerant is provided in the heat pipe.

6. The air conditioner for a vehicle according to claim 4,
wherein a refrigerant sealing valve for sealing a refrigerant is provided in the heat pipe.

7. The air conditioner for a vehicle according to claim 3,
wherein the plurality of refrigerant passages in rows of the evaporator are made of a pipe member.

8. The air conditioner for a vehicle according to claim 4,
wherein the plurality of refrigerant passages in rows of the evaporator are made of a pipe member.

9. The air conditioner for a vehicle according to claim 3,
wherein the plurality of refrigerant passages in rows of the evaporator are made of a plurality of plate members that are bonded to each other.

10. The air conditioner for a vehicle according to claim 4,
wherein the plurality of refrigerant passages in rows of the evaporator are made of a plurality of plate members that are bonded to each other.

11. The air conditioner for a vehicle according to claim 1,
wherein a refrigeration cycle to which the evaporator is connected includes a sealing portion capable of sealing a refrigerant that circulates through the inside in a refrigerant passage of the evaporator, and
wherein the heat pipe is formed in a state in which the refrigerant is sealed in the refrigerant passage by the sealing portion.

12. The air conditioner for a vehicle according to claim 2,
wherein a refrigeration cycle to which the evaporator is connected includes a sealing portion capable of sealing a refrigerant that circulates through the inside in a refrigerant passage of the evaporator, and
wherein the heat pipe is formed in a state in which the refrigerant is sealed in the refrigerant passage by the sealing portion.

13. The air conditioner for a vehicle according to claim 1,
wherein the inside air introduction passage and the outside air introduction passage are partitioned by a partition wall and disposed adjacent to each other, and
wherein a heat transfer member that exchanges heat between air that passes through the inside of the inside air introduction passage and air that passes through the inside of the outside air introduction passage is provided on the partition wall.

14. The air conditioner for a vehicle according to claim 2,
wherein the inside air introduction passage and the outside air introduction passage are partitioned by a partition wall and disposed adjacent to each other, and
wherein a heat transfer member that exchanges heat between air that passes through the inside of the inside air introduction passage and air that passes through the inside of the outside air introduction passage is provided on the partition wall.

15. The air conditioner for a vehicle according to claim 13,
wherein an insulating material for blocking heat exchange between outside air that passes through the inside of the outside air introduction passage and air in the surrounding region is disposed on the outer periphery of the outside air introduction passage.

16. The air conditioner for a vehicle according to claim 14,
wherein an insulating material for blocking heat exchange between outside air that passes through the inside of the outside air introduction passage and air in the surrounding region is disposed on the outer periphery of the outside air introduction passage.

17. The air conditioner for a vehicle according to claim 13,
wherein a drain passage from which condensed water generated from introduced air in the cabin is discharged to the outside is provided in the inside air introduction passage, and
wherein an air outlet from which introduced air in the cabin is discharged to the outside together with the condensed water is provided in the drain passage.

18. The air conditioner for a vehicle according to claim 14,
wherein a drain passage from which condensed water generated from introduced air in the cabin is discharged to the outside is provided in the inside air introduction passage, and
wherein an air outlet from which introduced air in the cabin is discharged to the outside together with the condensed water is provided in the drain passage.

19. The air conditioner for a vehicle according to claim 15,
wherein a drain passage from which condensed water generated from introduced air in the cabin is discharged to the outside is provided in the inside air introduction passage, and
wherein an air outlet from which introduced air in the cabin is discharged to the outside together with the condensed water is provided in the drain passage.

20. The air conditioner for a vehicle according to claim 16,
wherein a drain passage from which condensed water generated from introduced air in the cabin is discharged to the outside is provided in the inside air introduction passage, and
wherein an air outlet from which introduced air in the cabin is discharged to the outside together with the condensed water is provided in the drain passage.
